(19) United States
(12) Patent Application Publication
(10) Pub. No.: US 2026/0059404 A1
(43) Pub. Date: Feb. 26, 2026

(54) COORDINATION OF USER EQUIPMENT MOBILITY

(71) Applicant: QUALCOMM Incorporated, San Diego, CA (US)

(72) Inventors: Naeem AKL, Bridgewater, NJ (US); Junyi LI, Greentown, PA (US); Navid ABEDINI, Basking Ridge, NJ (US); Karl Georg HAMPEL, Jersey City, NJ (US)

(21) Appl. No.: 18/812,796

(22) Filed: Aug. 22, 2024

(51) Int. Cl. H04W 36/00; H04B 17/318

(52) U.S. Cl. CPC H04W 36/00837; H04B 17/328; H04W 36/0058

(57) ABSTRACT

Certain aspects of the present disclosure provide techniques for coordinating a mobility decision for a group of devices. A method generally includes obtaining one or more metrics associated with one or more cells; and sending, to one or more user equipments (UEs), an indication of a recommendation for a mobility decision for at least one cell of the one or more cells based on the one or more metrics. Another method generally includes obtaining, from each of one or more UEs, a respective vote for mobility to a cell; and sending, to the one or more UEs, a voting result for mobility to the cell based on the respective vote of each of the one or more UEs.

### FIELD OF THE DISCLOSURE

Aspects of the present disclosure relate to wireless communications, and more particularly, to techniques for user equipment (UE) mobility.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining one or more metrics associated with one or more cells; and sending, to one or more user equipments, an indication of a recommendation for a mobility decision for at least one cell of the one or more cells based on the one or more metrics.

Another aspect provides a method for wireless communications by an apparatus. The method includes obtaining, from each of one or more user equipments, a respective vote for mobility to a cell; and sending, to the one or more user equipments, a voting result for mobility to the cell based on the respective vote of each of the one or more user equipments.

Another aspect provides a method for wireless communications by an apparatus. The method includes receiving, from a second user equipment, an indication of a recommendation for a mobility decision for at least one cell; and performing a mobility operation in the at least one cell based on the recommendation.

Another aspect provides a method for wireless communications by an apparatus. The method includes sending, to an apparatus, a vote for mobility to a cell; and receiving, from the apparatus, a voting result for mobility to the cell.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example wireless communications network.

FIG. 6 depicts an example wireless communications network.

FIG. 7 depicts an example mobility scenario.

FIG. 8 depicts a process flow for communications in a network between a network entity and multiple devices.

FIG. 9 depicts a process flow for communications in a network between a network entity and multiple devices.

FIG. 10 depicts a method for wireless communications.

FIG. 11 depicts another method for wireless communications.

FIG. 12 depicts another method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for coordinating a mobility decision for a group of devices.

A wireless communication system may include a number of devices (e.g., terminals, network entities, and other devices) exchanging data, control information, reference signals, etc. (e.g., communicating) with each other. In some examples, a wireless communication system may generally include or refer to a number of devices and network entities employing techniques for exchanging information wirelessly. For example, a wireless communication system may include terminals (e.g., user devices or user equipments (UEs)) and network entities (e.g., base stations (BS)) that wirelessly communicate data, control information, reference signals, etc. (e.g., according to various wireless communication system implementations). Devices and network entities operating in a wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, improve the quality of communication between devices and network entities, etc.

As an example of the technologies for supporting communication between the increasing number of UEs and network entities, UEs may employ one or more types of mobility operations to reestablish and/or or transfer a connection with a network entity. In some aspects, the UEs may employ the one or more types of mobility operations based on a connectivity state of the UEs. For example, the connectivity state of the UEs may include an idle state (e.g., radio resource control (RRC) idle state), an inactive state (e.g., RRC inactive state), or a connected state (e.g., RRC connected state). For example, the idle state may correspond to times when a UE is not registered to a particular cell (e.g., but may still monitor for paging messages from the network), such that the UE may be in the idle state after powering up and/or if there is no activity to or from the UE for a certain amount of time. In some aspects, the idle state may refer to a UE having no RRC connection is established, but the UE may be known at a tracking-area level in a core network (CN). Additionally or alternatively, the inactive state may refer to a UE having an RRC connection that has been suspended, but the UE may be known on a radio access network (RAN)-based notification area (RNA) level in a particular RAN. Additionally or alternatively, the connected state may refer to a UE having an RRC connection established with the network, and the UE may be configured with parameters for communication with the network, such that the UE may be actively sending or receiving communications with a network entity.

Accordingly, a UE in the idle state or inactive state may perform a cell selection (e.g., a first mobility operation type) following registration with a network, following a transition to the idle state or inactive state, returning from an out of coverage area, or another situation where the UE is seeking to find a suitable or acceptable cell for establishing a connection with the network. In some aspects, the UE in the idle state or inactive state may perform the cell selection based on monitoring for, detecting, and/or measuring cell-defining (CD) synchronization signal blocks (SSBs) sent in one or more cells (e.g., by one or more network entities). For example, the UE in the idle state or the inactive state may monitor for paging messages in an initial bandwidth part (BWP) associated with the CD-SSBs and may perform the cell selection and measurements on the CD-SSBs.

Additionally or alternatively, a UE in the idle state or inactive state may perform a cell reselection (e.g., a second mobility operation type) based on monitoring for, detecting, and/or measuring the CD-SSBs sent in one or more cells (e.g., by one or more network entities). In some aspects, as part of the cell reselection, the UE in the idle state or inactive state may identify a cell on which to camp based on cell reselection criteria involving measurements of a serving cell (e.g., that the UE had previously established a connection with or is currently in service with) and/or one or more neighboring cells. Additionally, the UE in the idle state or inactive state may perform the cell reselection after having previously completed a cell selection, where the UE has then transitioned into the idle state or inactive state after the cell selection. Subsequently, the UE in the idle state or inactive state may perform the cell reselection while being covered by a registered cell and is able to detect the registered cell (e.g., the UE is still in service with the registered cell).

Additionally or alternatively, a UE in the connected state may perform a handover (e.g., a third mobility operation type) to transfer communications from a first cell to a second cell, which may require RRC signaling (e.g., at least for preparation of the handover). For example, the UE in the connected state may perform the handover based on Layer 3 (L3) measurements or Layer 1 (L1) measurements (e.g., measuring L3 or L1 reference signals from one or more cells that neighbor a serving cell and identifying one of the neighboring cells has a higher signal quality than the serving cell), load balancing (e.g., transferring the communications to the second cell to balance loads for each cell), network energy savings (NES) (e.g., the first cell reduces signaling to save energy, such that the communications for the UE are transferred to the second cell), or for another situation where transferring the communications to the second cell may provide a benefit for the UE or the network. Additionally, the handover may require admission control (e.g., the UE may need to receive admission and/or permission to perform the handover from the network). In some aspects, for a conditional handover (CHO), a UE may move from the first cell to the second cell upon fulfillment of execution conditions (e.g., as configured by the network) for the handover.

In some aspects, a group of UEs (e.g., multiple UEs) may move together from one cell to another cell (e.g., if the group of UEs are moving together, such as within a same moving vehicle), which may be referred to herein as group UE mobility. For connected-mode group mobility (e.g., each of the UEs in the group are in the connected state as described previously), a network entity and/or cell may bundle one or more UE-specific messages into a single message sent to the group of UEs (e.g., via unicast signaling to each of the UEs in the group or via group signaling, such as broadcasting, to the group of UEs). Additionally, the connected-mode group mobility may be used for integrated access and backhaul (IAB) systems, where backhaul (BH) communications with multiple UE tunnels (e.g., virtual communication paths) is migrated to a new IAB-donor (e.g., a network entity with wired BH connections). In some aspects, for on-the-air interface, group signaling of a handover command may be used for the group of UEs. Additionally, for CHO, group triggering of stored CHO configurations for each UE of the group of UEs may be used, and/or lower-layer broadcast messages may be used to modify the CHO execution conditions (e.g., evaluation conditions for determining whether to perform the CHO) for the UEs in the groups to encourage the UEs to leave a serving cell (e.g., source cell) if the serving cell is transitioning to an energy saving state (e.g., as part of NES).

In some aspects, the different types of mobility operations described previously may be initiated by the UE (e.g., UE-initiated types of mobility). For example, if the UE is in the idle state or the inactive state, then the UE may initiate the cell selection or cell reselection to establish a connection with a cell (e.g., for the cell selection) or camp on a cell (e.g., for the cell reselection). If the UE is in the connected state, then the UE may initiate and/or trigger the handover to transfer communications from a first cell to a second cell. For example, the UE may initiate and/or trigger the handover based on determining configurable mobility criteria for transferring the communications from the first cell to the second cell have been met (e.g., for CHO, conditional primary secondary cell (PSCell) addition and change (CPAC), cell lower-layer triggered mobility (C-LTM), etc.). Additionally or alternatively, the different types of mobility operations described previously may be initiated by the network (e.g., network-initiated types of mobility), where the network initiates the different types of mobility operations based on network implementation (e.g., to balance loads across multiple cells, for NES, based on cell measurements reported by the UE, etc.).

One or more technical problems arise for UE-initiated types of mobility for a group of UEs (e.g., UE-initiated group mobility). For example, UE-initiated mobility solutions may be based on evaluations of mobility criteria by individual UEs, which may not lead to optimal UE mobility decisions for a group of UEs moving together. Additionally, network configurations (e.g., where applicable) for UE-initiated mobility solutions may also be based on a configuration of mobility criteria to be evaluated by individual UEs, which is also not optimal for mobility of a group of UEs. In some aspects, direct intervention from the network to trigger group mobility for UE-initiated mobility solutions may be either infeasible (e.g., as for UEs in the idle state or inactive state) or blind (e.g., the network does not know a most recent CHO evaluation status for each of the UEs in the group, does not know which UEs are part of a group, etc.).

The techniques and signaling described herein provide a technical solution for enabling UE-initiated group mobility. As described herein, in certain aspects, for a group of UEs, one of the UEs in the group of UEs may be delegated as a leader UE for the group of UEs, where the leader UE provides a recommendation to the group of UEs for a mobility decision for the group of UEs. For example, the recommendation may indicate for the group of UEs to search for at least one cell of one or more cells, to switch to the at least one cell, or to avoid the at least one cell for a mobility operation. In some aspects, the leader UE may obtain one or more metrics associated with the one or more cells, where the recommendation is based on the one or more metrics. For example, the leader UE may perform more extensive measurements of the one or more cells (e.g., compared to the other UEs in the group of UEs) to determine the one or more metrics for the recommendation. For example, the leader UE may recommend to switch to or stay connected to a cell with higher measurements (e.g., higher signal-to-noise (SNR) measurements, higher signal power measurements, higher signal quality measurements, etc.) and/or may recommend to avoid a cell with lower measurements (e.g., lower SNR measurements, lower signal power measurements, lower signal quality measurements, etc.).

Additionally or alternatively, the leader UE may provide the recommendation based on receiving a request for the mobility decision from at least one of the other UEs in the group of UEs, receiving a recommendation of cell(s) (e.g., of the one or more cells) from at least one of the other UEs, and/or receiving one or more measurements of the one or more cells from the other UEs, where the request, recommendation, and/or measurements may represent the one or more metrics. For example, the leader UE may determine and provide the recommendation after receiving the request. Additionally or alternatively, the leader UE recommend to switch to or stay connected to a cell that is received in the recommendation of cell(s) from the at least one other UE (e.g., the provided recommendation is the same as the received recommendation of cell(s)). Additionally or alternatively, the leader UE may recommend to switch to a cell with higher measurements that are received from the other UEs and/or may recommend to avoid a cell with lower measurements that are received from the other UEs.

Additionally or alternatively, in certain aspects, the leader UE may provide the recommendation to the group of UEs, and each UE of the group of UEs may send respective votes for a mobility decision of a cell corresponding to the recommendation. For example, each UE may send a ‘yes’ vote or ‘no’ vote to the leader UE for the recommendation (e.g., to indicate to perform mobility to the cell or not perform mobility to the cell, respectively), and the leader UE may send a voting result to the group of UEs based on the respective votes. In some aspects, the voting result may be determined from a majority of the respective votes (e.g., whether the majority of the respective votes are ‘yes’ or ‘no’) or may be determined by a single vote of the respective votes (e.g., a single ‘yes’ vote may result in a ‘yes’ for the group of UEs or a single ‘no’ vote may result in a ‘no’ for the group of UEs). Additionally, each respective vote may include a respective confidence value for the respective vote (e.g., an associated time for which a signal strength measurement of the cell indicated by the recommendation is above a threshold value). In some aspects, a network entity may collect the respective votes from each UE in the group of UEs and may send the voting result to the group of UEs. In some aspects, the network entity may send a handoff command to the group of UEs (e.g., in addition to or in place of the voting result).

In certain aspects, the techniques for enabling UE-initiated group mobility as described herein may provide any of various beneficial effects and/or advantages. For example, the UE-initiated group mobility may provide a more optimal mobility decision for the group of UEs via the recommendation rather than each individual UE of the group of UEs making a mobility decision on its own. In some aspects, the leader UE performing measurements of the one or more cells may result in reduced power consumption of the other UEs in the group of UEs that do not then perform similar measurements. Additionally or alternatively, the leader UE may reduce its own power consumption by not performing the measurements and may obtain respective votes for the recommendation from the other UEs in the group of UEs. Additionally or alternatively, if the network entity provides the recommendation as described previously, then signaling overhead may decrease based on the network entity sending a single handover command to the group of UEs rather than sending individual handoff commands to each UE.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

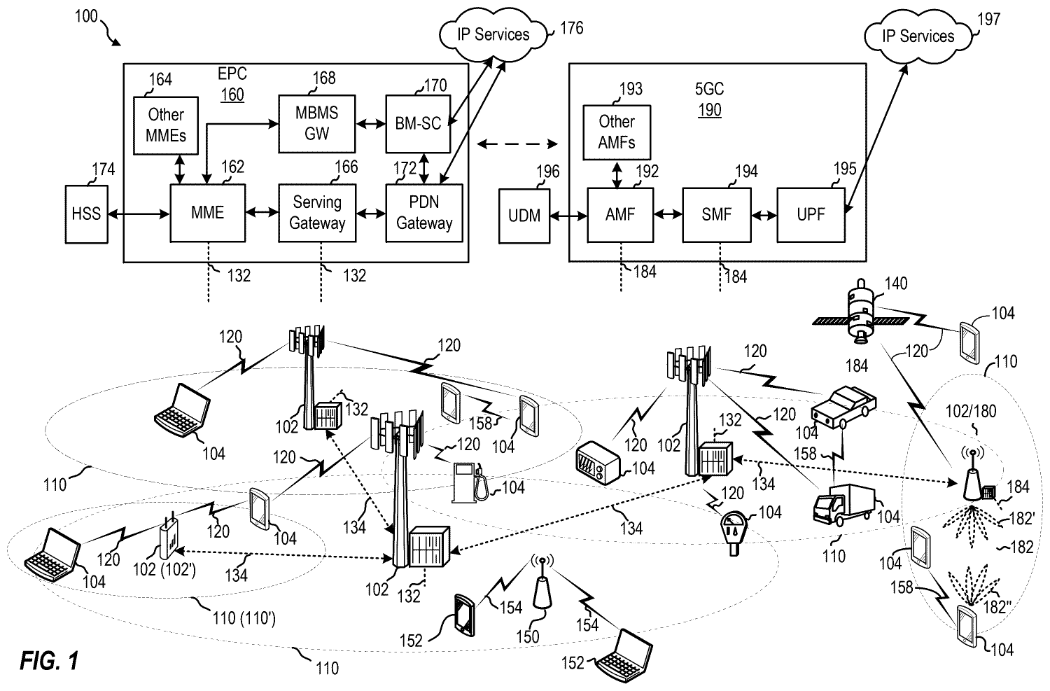

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

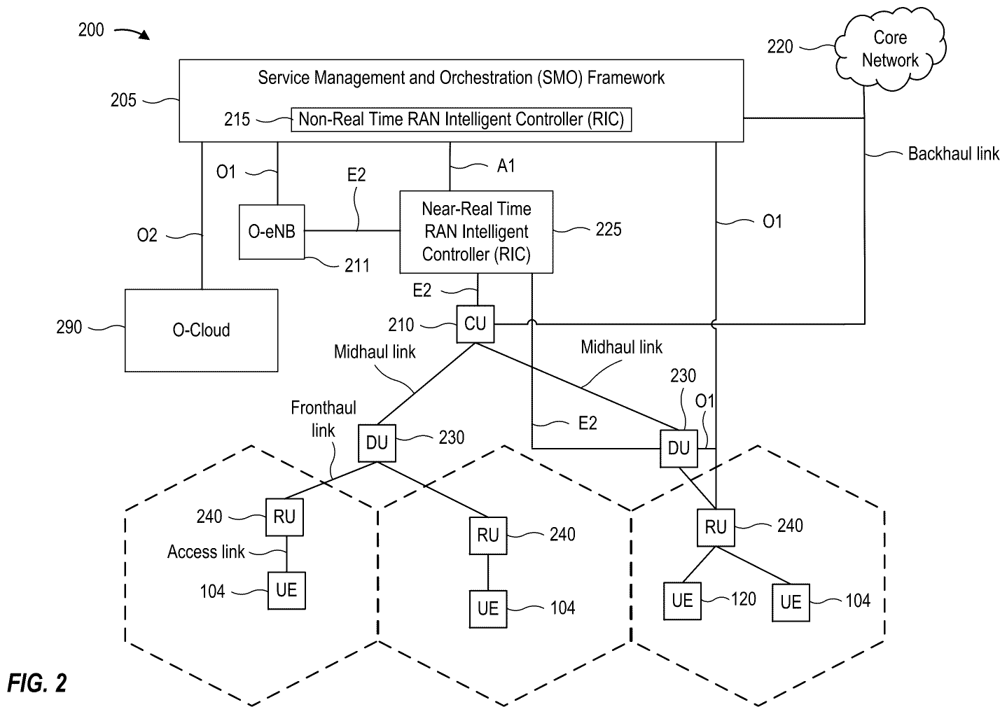

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

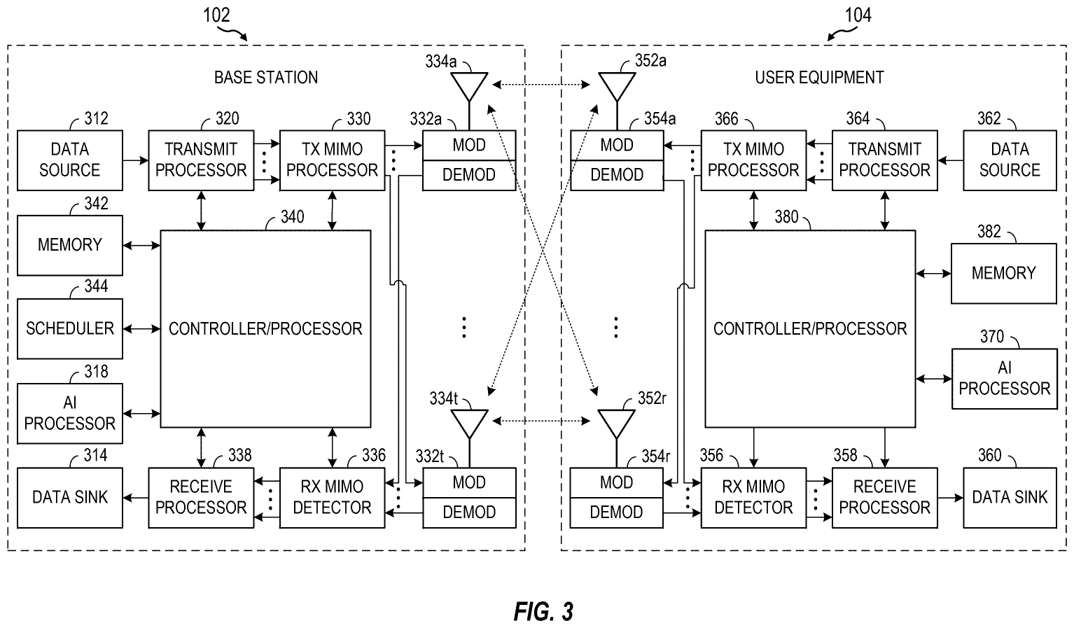

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

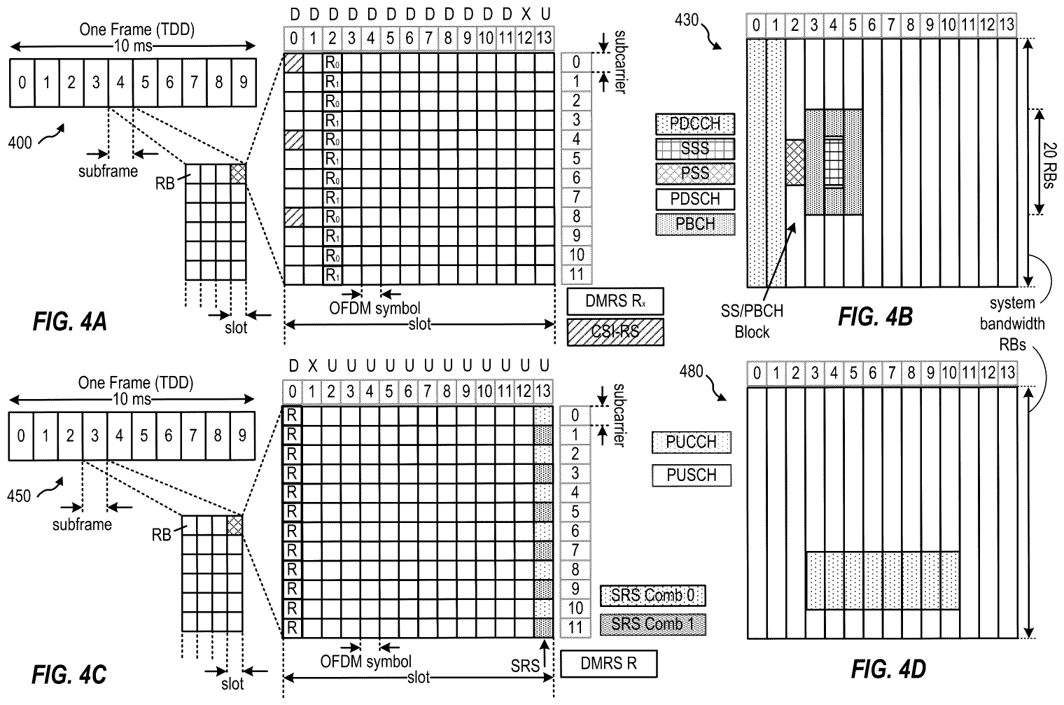

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μis the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Coordinating a Mobility Decision for a Group of Devices

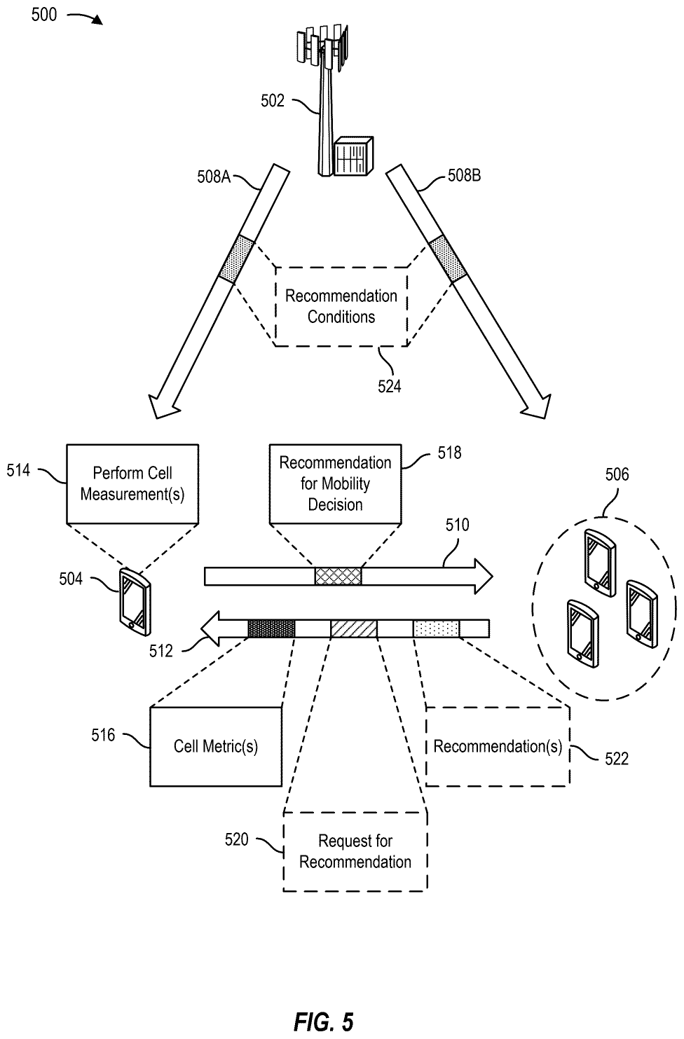

FIG. 5 depicts an example wireless communications network 500 that supports coordinating a mobility decision for a group of devices (e.g., UEs) in accordance with aspects of the present disclosure. In some examples, the wireless communications network 500 may implement aspects of or may be implemented by aspects of FIG. 1-4. For example, the wireless communications network 500 may include a network entity 502, a UE 504, and one or more secondary UEs 506, where the network entity 502 may represent a base station or similar network entity as described with reference to FIG. 1-3 (e.g., BS 102, BS 180, etc.) and the UE 504 and the secondary UEs 506 may represent respective UEs or similar terminal devices as described with reference to FIG. 1-3 (e.g., UE 104).

Additionally, the wireless communications network 500 may support communication between the network entity 502 and the UE 504 and/or the secondary UEs 506. For example, the network entity 502 and the UE 504 may wirelessly communicate via a first downlink communication link 508A (e.g., one or more carriers, a communication link 120, etc.), and the network entity 502 and the secondary UEs 506 may wirelessly communicate via a second downlink communication link 508B. Additionally, the wireless communications network 500 may support communication between the UE 504 and the secondary UEs 506. For example, the UE 504 and the secondary UEs 506 may wirelessly communicate via a first sidelink communication link 510 (e.g., one or more carriers, a communication link 120, etc.) and via a second sidelink communication link 512.

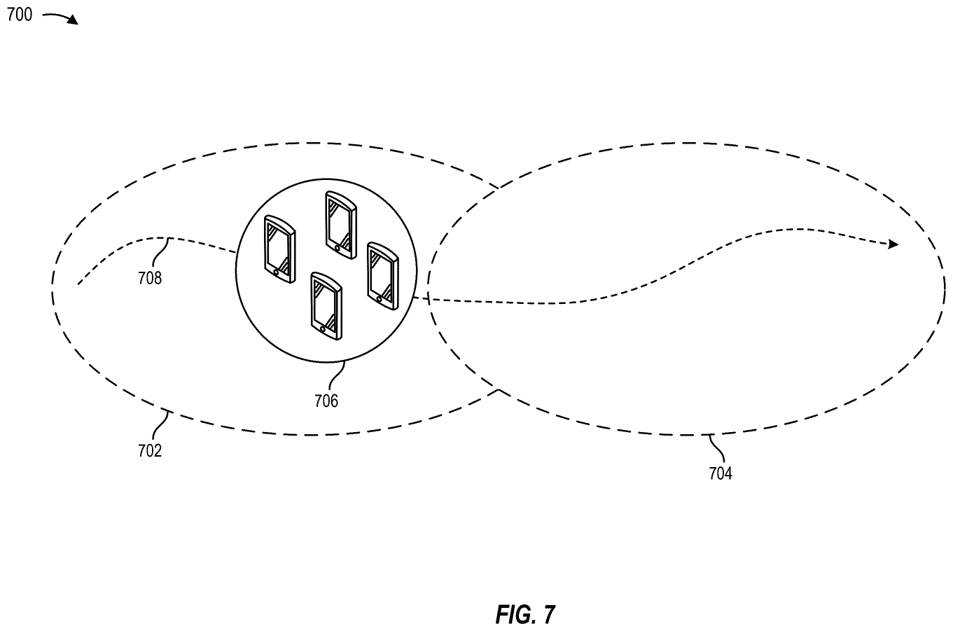

In some aspects, the UE 504 and the secondary UEs 506 may be part of a same group that experience similar link conditions. For example, the UE 504 and the secondary UEs 506 may be grouped together based on running a common application (e.g., via a same application server). Additionally or alternatively, the UE 504 and the secondary UEs 506 may be located in a same moving vehicle (e.g., as will be described with reference to FIG. 7), and the UE 504 and the secondary UEs 506 may discover that they are located near each other, such as based on a proximity service employed by the UEs, where the group is determined based on being located near each other. In such aspects, the UE 504 and the secondary UEs 506 may form the grouping. Additionally or alternatively, the network entity 502 may indicate a configuration of the group to the UE 504 and the secondary UEs 506. In some aspects, each of the UE 504 and the secondary UEs 506 in the group may be in any of the connectivity states as described previously (e.g., idle state, inactive state, or connected state).

As described herein, the UE 504 and the secondary UEs 506 within the group may coordinate for mobility decisions for the group (e.g., a decision on whether or not to perform a mobility operation for the group). For example, the mobility decisions may include determining to perform and/or performing a cell selection, cell reselection, or handover (e.g., as described previously) for the group. Assuming link conditions between a target cell and each UE within the group are similar (e.g., which may be at least part of a basis for UE group formation), group-UE mobility decisions may be more robust compared to each individual UE making a respective mobility decision (e.g., based on cell measurements performed by each individual UE, which may vary by accuracy).

In some aspects, the UE 504 may be elected as a leader UE for the group, such that the UE 504 is elected to make mobility decisions for the secondary UEs 506. For example, the UE 504 may be elected as the leader UE based on capabilities and/or characteristics of the UE 504 (e.g., power level, power consumption, amount of remaining battery power, processing capabilities, number of antennas, etc.). In some aspects, the UE 504 may be elected as the leader UE by the group (e.g., the UE 504 and the secondary UEs 506). Additionally or alternatively, the UE 504 may be designated as the leader UE by the network entity 502. Additionally, the leader UE may change over time. For example, the UE 504 may be the leader UE in the example of FIG. 5, but one of the secondary UEs 506 and/or another UE may be elected as the leader UE previously and/or at a later time. In some aspects, the UE 504 may receive authorization (e.g., from the network entity 502 or a different network entity not illustrated in the example of FIG. 5) to perform group-UE mobility decisions for itself and the secondary UEs 506 (e.g., group-based UE decisions).

Accordingly, as the leader UE, the UE 504 may obtain one or more metrics associated with one or more cells for determining a target cell recommendation and/or recommendation for a mobility decision for itself and the secondary UEs 506. For example, the UE 504 may perform one or more measurements 514 for the one or more cells (e.g., measuring one or more reference signals associated with at least one of the one or more cells, such as CD-SSBs, CSI-RSs, DMRSs etc.), such as reference signal received power (RSRP) measurements, reference signal received quality (RSRQ) measurements, received signal strength indicator (RSSI) measurements, signal-to-interference-plus-noise ratio (SINR) measurements, etc.

In some aspects, the UE 504 may determine the target cell recommendation and/or the recommendation for the mobility decision based on which cell(s) have higher measurements (e.g., higher SNR or SINR measurements, higher RSRP measurements, higher RSRQ measurements, etc.) and/or based on which cell(s) have lower measurements (e.g., lower SNR or SINR measurements, lower RSRP measurements, lower RSRQ measurements, etc.). Additionally, the UE 504 may perform more extensive measurements of the one or more cells compared to the secondary UEs 506 (e.g., over a longer time period, a higher number of measurements, measurements on a higher number of reference signals, measurements via a higher number of beams, etc.).

Additionally or alternatively, the secondary UEs 506 may consult with the UE 504 on respective mobility decisions determined by each UE of the secondary UEs 506. For example, the UE 504 may receive one or more cell metrics 516 from the secondary UEs 506 (e.g., via the first sidelink communication link 512) for the one or more cells, such as individual measurements of the one or more cells performed by one or more UEs of the secondary UEs 506, assistance information for the individual measurements (e.g., cell identifiers (IDs) associated with each of the individual measurements, which reference signals were measured from which of the one or more cells, when the individual measurements were performed, etc.), determinations of mobility decisions for the one or more cells performed by one or more UEs of the secondary UEs 506, etc.

Subsequently, after obtaining the one or more metrics associated with the one or more cells (e.g., performing the one or more measurements 514 and/or receiving the one or more cell metrics 516), the UE 504 may send a recommendation 518 (e.g., via the first sidelink communication link 510) for a mobility decision for the secondary UEs 506. For example, the recommendation 518 may include a recommendation for the secondary UEs 506 to search for at least one cell of the one or more cells (e.g., which cell(s) to search for to potentially perform a cell selection, a cell reselection, or a handover). In some aspects, the recommendation for the secondary UEs 506 to search for the at least one cell of the one or more cells may be determined from which cells had higher measurements (e.g., from the UE 504 and/or the secondary UEs 506), the determinations of mobility decisions performed by one or more UEs of the secondary UEs 506, etc.

Additionally or alternatively, the recommendation 518 may include a recommendation for the secondary UEs 506 to switch to at least one cell of the one or more cells (e.g., which cell(s) to switch to for a cell reselection or a handover). In some aspects, the recommendation for the secondary UEs 506 to switch to the at least one cell of the one or more cells may be determined from which cells had higher measurements (e.g., from the UE 504 and/or the secondary UEs 506), the determinations of mobility decisions performed by one or more UEs of the secondary UEs 506, etc.

Additionally or alternatively, the recommendation 518 may include a recommendation for the secondary UEs 506 to avoid and/or dismiss for a mobility operation for at least one cell of the one or more cells (e.g., which cell(s) to avoid and/or dismiss for a cell selection, a cell reselection, or a handover). In some aspects, the recommendation for the secondary UEs 506 to avoid and/or dismiss the at least one cell of the one or more cells for the mobility operation for at least one cell of the one or more cells may be determined from which cells had lower measurements (e.g., from the UE 504 and/or the secondary UEs 506), the determinations of mobility decisions performed by one or more UEs of the secondary UEs 506, etc. In some aspects, the UE 504 may send the recommendation 518 via unicast signaling to each of the secondary UEs 506 or via group signaling (e.g., broadcast, multicast, multicast-broadcast services (MBS), etc.) to the secondary UEs 506.

In some aspects, the recommendation 518 may include an indication of a target cell ID associated with at least one cell of the one or more cells. Additionally or alternatively, the recommendation 518 may include a signal strength associated with the target cell ID. In some aspects, the signal strength may be accompanied with a confidence value (e.g., a time duration that the signal strength for the cell associated with the target cell ID is above a threshold value). Additionally or alternatively, the recommendation 518 may include an indication that the UE 504 has determined to perform a mobility operation (e.g., cell selection, cell reselection, handover, CHO, etc.) or has performed the mobility operation for a cell of the one or more cells, and the indication may be leveraged by the secondary UEs 506 (e.g., the secondary UEs 506 may search for and/or switch to the cell of the one or more cells).

In some aspects, the UE 504 may collect the one or more cell metrics 516 from the secondary UEs 506 and may feed (e.g., input) the one or more cell metrics 516 (e.g., and/or the one or more measurements 514) into a ML model (e.g., AI model). Subsequently, the ML model may generate an output that indicates whether to trigger or not trigger a mobility operation (e.g., cell selection, cell reselection, or handover) towards at least one cell of the one or more cells based on the one or more cell metrics 516 (e.g., and/or the one or more measurements 514). For example, the ML model may be trained to determine whether a cell is suitable or desired for the mobility operation for the UE 504 and the secondary UEs 506 based on inputs into the ML model, such as the one or more cell metrics 516 and/or the one or more measurements 514. Accordingly, the UE 504 may obtain the output from the ML model and may include the output as the recommendation 518.

In some aspects, the UE 504 may send the recommendation 518 proactively or upon receiving consultation from at least one of the secondary UEs 506. For example, the UE 504 may send the recommendation 518 proactively when a cell measurement becomes stronger than a threshold value (e.g., based on the one or more measurements 514). Additionally or alternatively, the UE 504 may send the recommendation 518 upon receiving a request 520 for a recommendation from at least one of the secondary UEs 506 (e.g., via the second sidelink communication link 512). In some aspects, the at least one of the secondary UEs 506 may send the request 520 via unicast signaling (e.g., to the UE 504) or group signaling (e.g., to the UE 504 and the other UEs of the secondary UEs 506).

Additionally or alternatively, the UE 504 may send the recommendation 518 upon receiving, from at least one of the secondary UE 506, one or more respective recommendations 522 (e.g., via the second communication link 512) of at least one cell of the one or more cells and/or the one or more cell metrics 516. For example, one or more of the secondary UEs 506 may determine at least one cell of the one or more cells is suitable for a mobility operation (e.g., CHO execution conditions are fulfilled, cell measurements exceed a threshold value, etc.) and may send a recommendation 522 indicating the at least one cell. Accordingly, the UE 504 may send the recommendation 518 for the mobility decision based on the one or more respective recommendations 522. For example, a cell indicated in the one or more respective recommendations 522 may be indicated in the recommendation 518. Additionally or alternatively, the UE 504 may determine to indicate a different cell in the recommendation 518 than which cell(s) are indicated in the one or more respective recommendations 522.

In some aspects, the UE 504 and/or the secondary UEs 506 may receive (e.g., from the network entity 502, such as via the respective downlink communication links 508) a configuration of one or more conditions 524 on which to base the recommendation 518 and/or the one or more recommendations 522, respectively (e.g., assuming the UE 504 and/or the secondary UEs 506 are in connected state with the network entity 502 and are configured for a conditional mobility operation, such as CHO, CPAC, C-LTM, etc.). For example, the configuration of the one or more conditions 524 may enable UE-initiated mobility (e.g., a mobility decision performed by the UE 504 and indicated in the recommendation 518) based on a group-UE decision. In some aspects, the network entity 502 may indicate multiple configurations (e.g., and corresponding conditions), where the multiple configurations may be indicated and used for different groups of UEs and/or different group sizes. Additionally, the network entity 502 may indicate the configuration of the one or more conditions 524 along with a configuration for individual-UE mobility decisions.

For example, the network entity 502 may provide the UE 504 with a configuration of one or more conditions 524 for an individual cell assessment (e.g., a cell assessment performed by and for an individual UE) for determining to perform a mobility operation or not (e.g., a mobility decision) and may provide the secondary UEs 506 with a configuration of one or more conditions 524 (e.g., in a same configuration message or a different configuration message) for a group-UE assessment (e.g., a cell assessment performed by and for a group of UEs) for determining to perform a mobility operation or not. Additionally or alternatively, the network entity 502 may provide the UE 504 with the configuration of the one or more conditions 524 for both the individual cell assessment and the group-UE assessment. Similarly, in some aspects, the network entity 502 may provide the secondary UEs 506 with the configuration of the one or more conditions 524 for both the individual cell assessment and the group-UE assessment.

In some aspects, the UE 504 may perform a CHO based on the one or more conditions 524 being fulfilled. For example, the one or more conditions 524 may include a first signal strength of the at least one cell at the UE 504 satisfying a first threshold for the individual cell assessment (e.g., an RSRP measured for the at least one cell by the UE 504 being greater than the first threshold, such as RSRP>TH1). Additionally or alternatively, the one or more conditions 524 may include the first signal strength of the at least one cell at the UE 504 satisfying a second threshold for the individual cell assessment (e.g., the RSRP measured for the at least one cell by the UE 504 being greater than the second threshold, such as RSRP>TH2) and a second signal strength of the at least one cell for at least one UE of the secondary UEs 506 satisfying a third threshold for the group-UE assessment (e.g., an RSRP measured for the at least one cell by the at least one UE of the secondary UEs 506 being greater than the third threshold, such as RSRP>TH2′).

Additionally or alternatively, the one or more conditions 524 may include the first signal strength of the at least one cell at the UE 504 satisfying the second threshold for the individual cell assessment (e.g., RSRP>TH2) and the at least one cell being recommended by at least one UE of the secondary UEs 506 (e.g., via the one or more recommendations 522). Additionally or alternatively, the one or more conditions 524 may include the first signal strength of the at least one cell at the UE 504 satisfying the second threshold for the individual cell assessment (e.g., RSRP>TH2) and the at least one cell being recommended by a number of the secondary UEs 506 that satisfies a threshold number of recommendations (e.g., the at least one cell is recommended by ‘X’ UEs of the secondary UEs 506).

In some aspects, if the UE 504 and/or the secondary UEs 506 are in an idle state or inactive state, then the network entity may indicate the one or more conditions 524 via a first system information (SI) message that configures cell selection and/or cell reselection criteria based on individual UE assessment and a second SI message that configures separate cell selection and/or cell reselection criteria based on group-UE assessment. The cell selection and/or cell reselection criteria may correspond to the one or more conditions 524 described previously. Additionally, in some aspects, the network entity 502 may activate or deactivate group-based mobility decisions for the UE 504 and/or the secondary UEs 506, may assist the UEs in forming a group, etc.

In some aspects, based on the techniques and signaling described with reference to FIG. 5, at least one UE of the secondary UEs 506 may determine a cell as candidate cell for mobility. The at least one UE of the secondary UEs 506 may then check with one or more other UEs on that cell to determine whether the cell is suitable for the mobility and/or may send the request 520 to the UE 504 to receive the recommendation 518. Subsequently, the at least one UE of the secondary UEs 506 may receive the recommendation 518 and may perform or skip mobility to the cell based on the recommendation 518.

Additionally or alternatively, based on the techniques and signaling described with reference to FIG. 5, the UE 504 may receive the recommendation 522 for a candidate cell for mobility from one or more UEs of the secondary UEs 506. In some aspects, the recommendation 522 may carry assistance information for searching for that cell (e.g., cell ID, cell measurements, reference signals sent via the cell, etc.). Subsequently, the UE 504 may prioritize a search for that cell based on the recommendation 522. In some aspects, the UE 504 may then switch to the cell based on the recommendation 522 and based on detecting the cell with a signal strength measurement for the cell that satisfies a threshold value. Additionally or alternatively, the secondary UEs 506 may receive the recommendation 518 for a candidate cell for mobility from the UE 504, where the recommendation 518 may include the assistance information for searching for that cell. Subsequently, the secondary UEs 506 may prioritize a search for that cell based on the recommendation 518 and may then switch to the cell (e.g., based on the recommendation 518) based on detecting the cell with a signal strength measurement for the cell that satisfies a threshold value.

### Aspects Related to Coordinating a Mobility Decision for a Group of Devices Based on a Voting Result

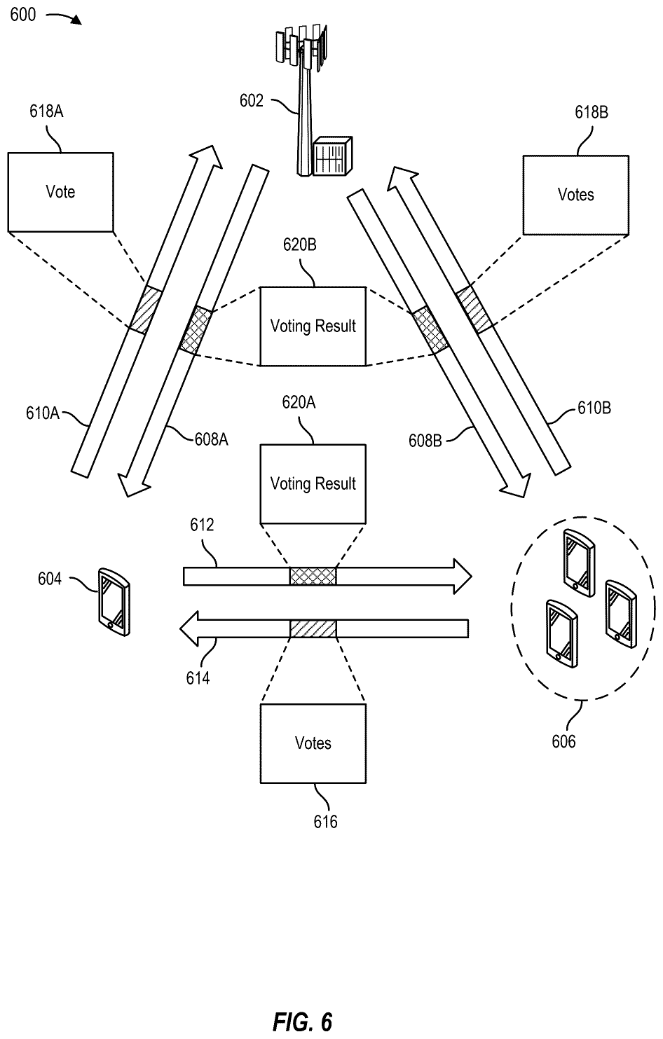

FIG. 6 depicts an example wireless communications network 600 that supports coordinating a mobility decision for a group of devices (e.g., UEs) based on a voting result in accordance with aspects of the present disclosure. In some examples, the wireless communications network 600 may implement aspects of or may be implemented by aspects of FIG. 1-5. For example, the wireless communications network 500 may include a network entity 602, a UE 604, and one or more secondary UEs 606, where the network entity 602 may represent a base station or similar network entity as described with reference to FIG. 1-3 and 5 (e.g., BS 102, BS 180, network entity 502, etc.) and the UE 604 and the secondary UEs 606 may represent respective UEs or similar terminal devices as described with reference to FIG. 1-3 and 5 (e.g., UE 104, UE 504, secondary UEs 506, etc.).

Additionally, the wireless communications network 600 may support communication between the network entity 602 and the UE 604 and/or the secondary UEs 606. For example, the network entity 602 and the UE 604 may wirelessly communicate via a first downlink communication link 608A (e.g., one or more carriers, a communication link 120, etc.) and via a first uplink communication link 610A (e.g., one or more carriers, a communication link 120, etc.), and the network entity 602 and the secondary UEs 606 may wirelessly communicate via a second downlink communication link 608B and via a second uplink communication link 610B. Additionally, the wireless communications network 600 may support communication between the UE 604 and the secondary UEs 606. For example, the UE 604 and the secondary UEs 606 may wirelessly communicate via a first sidelink communication link 612 (e.g., one or more carriers, a communication link 120, etc.) and via a second sidelink communication link 614.

As described with reference to FIG. 5, the UE 604 and the secondary UEs 606 may be part of a same group (e.g., that experience similar link conditions), and the UE 604 may be elected as a leader UE for the group. Additionally, the UE 604 and the secondary UEs 606 within the group may coordinate for mobility decisions for the group (e.g., a decision on whether or not to perform a mobility operation for the group), where the UE 604 may receive authorization (e.g., from the network entity 602 or a different network entity not illustrated in the example of FIG. 6) to perform group-UE mobility decisions for itself and the secondary UEs 606 (e.g., group-based UE decisions).

In the example of FIG. 6, the UE 604 may obtain, from each of the secondary UEs 606 (or less than all of the secondary UEs 606), a respective vote 616 (e.g., via the second sidelink communication link 614) for mobility to a cell. For example, each of the respective votes 616 may indicate to perform mobility to the cell or not perform mobility to the cell for each corresponding UE of the secondary UEs 606 (e.g., a mobility triggering vote to indicate whether each UE of the secondary UEs 606 approve of performing a mobility operation to the cell or not, such as a cell selection, a cell reselection, or a handover). In some aspects, each of the secondary UEs 606 may provide their respective votes 616 after receiving a recommendation for the cell from the UE 604 (e.g., the recommendation 518 as described with reference to FIG. 5). Additionally or alternatively, each of the secondary UEs 606 may provide their respective votes 616 proactively (e.g., without receiving a recommendation of the cell from the UE 604). For example, each of the secondary UEs 606 may provide their respective votes 616 for one or more cells (e.g., that include the cell). In certain aspects, a UE 606 may only provide a vote 616 when approving of (or alternatively disapproving of) a mobility to a cell, and lack of a vote 616 from a UE 606 may indicate disapproving of (or alternatively approving of) mobility to the cell.

Additionally or alternatively, the network entity 602 may obtain, from the UE 604 and each of the secondary UEs 606, a respective vote 618 (e.g., via the first uplink communication link 610A and the second uplink communication link 610B, respectively) for mobility to the cell. For example, the UE 604 may send a vote 618A to the network entity 602 for mobility to the cell, and the secondary UEs 606 may send a respective vote 618B to the network entity 602 for mobility to the cell. In some aspects, the UE 604 and each of the secondary UEs 606 may provide their respective votes 618 proactively (e.g., without receiving a recommendation of the cell from the network entity 602). For example, the UE 604 and each of the secondary UEs 606 may provide their respective votes 618 for one or more cells (e.g., that include the cell).

In some aspects, the votes (e.g., the respective votes 616 or the respective votes 618) may be expressed as a ‘yes’ (e.g., to indicate approval of performing mobility to the cell) or a ‘no’ (e.g., to indicate performing mobility to the cell is not approved). Additionally or alternatively, the votes may be expressed as the ‘yes’ or ‘no’ with respect to a signal strength measurement for the cell (e.g., measured by each respective UE). For example, weights per signal strength measurement may be used to send the votes. That is, the votes may be sent with a respective confidence value for each of the votes. For example, the confidence value may indicate an associated time for which a signal strength measurement corresponding to the cell for each UE was above a threshold value. In some aspects, the confidence value and/or a confidence percentage may be generated by a ML and/or AI model (e.g., for AI-based mobility) employed by each UE.

Subsequently, after obtaining the respective votes, the UE 604 or the network entity 602 may send a voting result for the mobility to the cell. For example, the UE 604 may send a voting result 620A to the secondary UEs 606 (e.g., via the first sidelink communication link 612) based on the respective votes 616. Additionally or alternatively, the network entity 602 may send a voting result 620B to the UE 604 and the secondary UEs 606 (e.g., via the first downlink communication link 608A and the second downlink communication link 608B, respectively) based on the respective votes 618. In some aspects, the UE 604 and/or the network entity 602 may send the voting result 620 via unicast signaling or group signaling.

In some aspects, the network entity 602 may obtain the respective votes 618 and send the voting result 620B based on receiving a handoff request from at least one of the UEs (e.g., the UE 604 and/or at least one of the secondary UEs 606), where absence of a handoff request may be indicative of a corresponding UE not wanting to perform a handoff. Accordingly, if a handoff request is received from at least one of the UEs, then the voting result 620B may include a handoff command to the cell for the UE 604 and the secondary UEs 606. In some aspects, the content of the handoff command may be up to network implementation (e.g., the network entity 602 determines the content of the handoff command).

In some aspects, the voting result 620 may be determined from a majority among the respective votes (e.g., whether the majority of the respective votes are ‘yes’ or ‘no’). Additionally or alternatively, the voting result 620 may be determined by a single vote of the respective votes (e.g., a single ‘yes’ vote may result in a ‘yes’ for the mobility to the cell for all UEs or a single ‘no’ vote may result in a ‘no’ for the mobility to the cell for all UEs). In some aspects, the voting result 620 may be further based on the confidence values (e.g., as described previously) for the respective votes. For example, if the confidence values indicate respective signal strength measurements from each UE for the cell are above a threshold value for a longer duration than being below the threshold value (e.g., as indicated by a percentage value), then the voting result may indicate for the UEs to perform the mobility to the cell. Additionally or alternatively, if the confidence values indicate respective signal strength measurements from each UE for the cell are below the threshold value for a longer duration than being above the threshold value, then the voting result may indicate for the UEs to skip (e.g., not perform) the mobility to the cell.

### Aspects Related to Mobility Scenarios

FIG. 7 depicts an example mobility scenario 700. In some examples, the mobility scenario 700 may implement aspects of or may be implemented by aspects of FIG. 1-6. For example, the mobility scenario 700 may include a first coverage area 702 associated with a first cell and a second coverage area 704 associated with a second cell, where the first coverage area 702 and the second coverage area 704 may represent a coverage area 110 as described with reference to FIG. 1. Additionally, the mobility scenario may include a group of UEs 706, where the group of UEs 706 may represent respective UEs or similar terminal devices as described with reference to FIG. 1-3 and 5-6 (e.g., UE 104, UE 504, secondary UEs 506, UE 604, secondary UEs 606, etc.).

As described herein, the group of UEs 706 may experience similar link conditions, run a common application, and/or may be located near each other (e.g., as determined by a proximity service). In the example of FIG. 7, the group of UEs 706 may be located in a same moving vehicle, where the group of UEs 706 are moving along a trajectory 708 (e.g., trajectory of UE mobility).

In some aspects, the group of UEs 706 may be initially located in the first coverage area 702 and, as such, may be communicating via the first cell. However, based on the trajectory 708, the group of UEs 706 may be moving outside the first coverage area 702 and out of coverage of the first cell. Accordingly, it may be desirable for the group of UEs 706 to perform a mobility operation (e.g., as described previously) to establish communications with a different cell than the first cell and/or transfer communications from the first cell to the different cell. In the example of FIG. 7, it may be desirable for the group of UEs 706 to perform the mobility operation to establish communications and/or transfer communications with the second cell based on the trajectory 708 showing that the group of UEs 706 are moving towards or within the second coverage area 704.

Accordingly, as described with reference to FIGS. 5 and 6, the group of UEs 706 may coordinate for mobility decisions for the group to perform the mobility operation to establish communications and/or transfer communications with the second cell for each UE in the group of UEs 706. For example, as described with reference to FIG. 5, a UE in the group of UEs 706 may be elected as a leader UE and may provide a recommendation indicating the second cell for the mobility operation (e.g., based on performing signal measurements on the second cell, obtaining cell metrics for the second cell, etc.). Additionally or alternatively, as described with reference to FIG. 6, the leader UE and/or a network entity may collect respective votes for mobility to the second cell from each of the UEs in the group of UEs 706 and may send a voting result to the group of UEs 706, where the voting result indicates for the group of UEs to perform the mobility to the second cell.

### Example Signaling of Coordinating a Mobility Decision for a Group of Devices

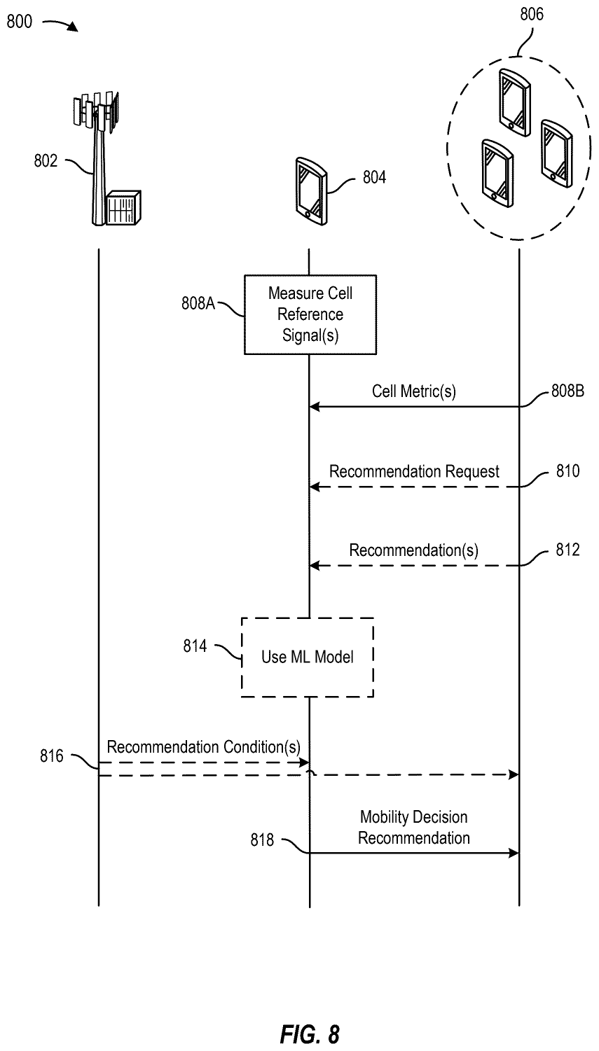

FIG. 8 depicts a process flow 800 for communications in a network between a network entity and multiple devices. In some aspects, the process flow 800 may implement aspects of or may be implemented by aspects of FIG. 1-5 and 7. For example, the process flow 800 may include a network entity 802, a UE 804, and one or more secondary UEs 806. The network entity 802 may represent a base station or similar network entity as described with reference to FIG. 1-3, 5, and 7 (e.g., BS 102, BS 180, network entity 502, etc.), and the UE 804 and the secondary UEs 806 may represent respective UEs or similar terminal devices as described with reference to FIG. 1-3, 5, and 7 (e.g., UE 104, UE 504, secondary UEs 506, group of UEs 706, etc.). In some aspects, the process flow 800 may represent a wireless communications network for coordinating a mobility decision for a group of devices as described with reference to FIG. 5. Note that any operations or signaling illustrated with dashed lines may indicate that that operation or signaling is an optional or alternative example.

At 808, the UE 804 obtains one or more metrics associated with one or more cells. For example, at 808A, the UE 804 measures one or more reference signals (e.g., the one or more measurements 514 as described with reference to FIG. 5) associated with at least one cell of the one or more cells. Additionally or alternatively, at 808B, the UE 804 receives at least one of the one or more metrics (e.g., the one or more cell metrics 516 as described with reference to FIG. 5) from the secondary UEs 806.

At 810, the UE 804 may receive, from at least one UE of the secondary UEs 806, a request for a recommendation for a mobility decision (e.g., the request 520 as described with reference to FIG. 5).

At 812, the UE 804 may receive, from at least one UE of the secondary UEs 806, a respective recommendation for the at least one cell (e.g., the one or more recommendations 522 as described with reference to FIG. 5).

At 814, the UE 804 may input the one or more metrics into a ML model and may receive, as output from the ML model, a recommendation for a mobility decision.

At 816, the UE 804 and/or the secondary UEs 806 may receive, from the network entity 802, a configuration of one or more conditions on which to base the recommendation for the mobility decision (e.g., the one or more conditions 524 as described with reference to FIG. 5). For example, the one or more conditions may include one or more of: a first signal strength of the at least one cell at the UE 804 satisfying a first threshold; a second signal strength of the at least one cell at a UE of the secondary UEs 806 satisfying a second threshold; reception of a recommendation of the at least one cell from the UE of the secondary UEs 806; or reception of a threshold number of recommendations of the at least one cell from the secondary UEs 806. In some aspects, the UE 804 and/or the secondary UEs 806 may receive the configuration of the one or more conditions earlier than depicted in the example of FIG. 8.

In some aspects, the UE 804 and/or the secondary UEs 806 may receive, from the network entity 802, a second configuration of one or more second conditions on which to base the recommendation for the mobility decision, where the configuration is for individual user equipment mobility assessment and the second configuration is for group user equipment mobility assessment. In some aspects, the UE 804 and/or the secondary UEs 806 may receive, from the network entity 802, an indication to active or deactivate one or more of individual user equipment mobility assessment or group user equipment mobility assessment.

At 818, the UE 804 may send, to the secondary UEs 806, an indication of the recommendation for the mobility decision for the at least one cell of the one or more cells (e.g., the recommendation 518 as described with reference to FIG. 5) based on the one or more metrics. In some aspects, the UE 804 and/or each of the secondary UEs 806 may perform a mobility operation in the at least one cell based on the recommendation (e.g., the UE 804 and/or each of the secondary UEs 806 may or may not follow the recommendation when performing the mobility operation). For example, the recommendation may include a recommendation to search for the at least one cell, a recommendation to switch to the at least one cell, and/or a recommendation to avoid the at least one cell for mobility to the one or more cells. In some aspects, the UE 804 may send the indication of the recommendation in response to a metric associated with the at least one cell satisfying a threshold. Additionally or alternatively, the UE 804 may send the indication of the recommendation based on (e.g., in response to) receiving the request for the recommendation (e.g., at 810). In some aspects, the UE 804 may unicast or broadcast (e.g., or a different type of group signaling) the indication to each of the secondary UEs 806.

In some aspects, the indication of the recommendation may include an indication that the UE 804 has determined to perform mobility to the at least one cell. Additionally or alternatively, the indication of the recommendation may include a target cell ID associated with the at least one cell. Additionally or alternatively, the indication of the recommendation may include a signal strength associated with the at least one cell. Additionally or alternatively, the recommendation for the mobility decision for the at least one cell may be based on the respective recommendation from the at least one UE of the secondary UEs 806 (e.g., received at 812).

Note that the process flow illustrated in FIG. 8 is an example of coordinating a mobility decision for a group of devices, and aspects of the present disclosure may be applied to coordinating a mobility decision for a group of devices. Note that the process flow illustrated in FIG. 8 is described herein to facilitate an understanding of coordinating a mobility decision for a group of devices, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Signaling of Coordinating a Mobility Decision for a Group of Devices Based on a Voting Result

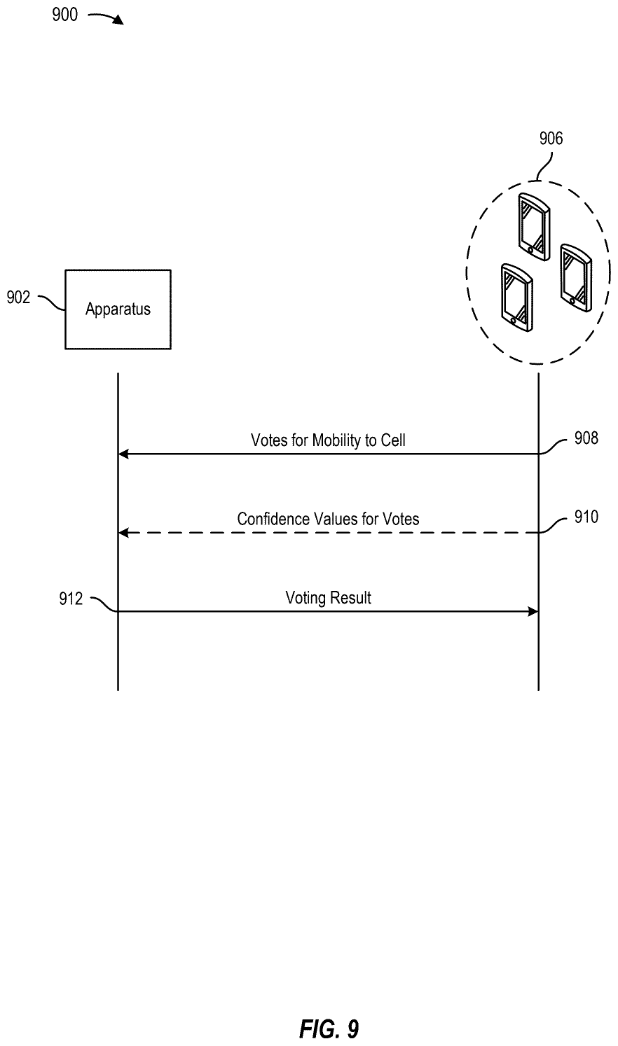

FIG. 9 depicts a process flow 900 for communications in a network between a network entity and multiple devices. In some aspects, the process flow 900 may implement aspects of or may be implemented by aspects of FIG. 1-4 and 6-7. For example, the process flow 900 may include an apparatus 902 and a group of UEs 906. The apparatus 902 may represent a base station or similar network entity as described with reference to FIG. 1-3, 6, and 7 (e.g., BS 102, BS 180, network entity 602, etc.) or a UE or similar terminal device as described with reference to FIG. 1-3, 6, and 7 (e.g., UE 104, UE 604, etc.), and the group of UEs 906 may represent also respective UEs or similar terminal devices as described with reference to FIG. 1-3, 6, and 7 (e.g., UE 104, secondary UEs 606, group of UEs 706, etc.). In some aspects, the process flow 900 may represent a wireless communications network for coordinating a mobility decision for a group of devices based on a voting result as described with reference to FIG. 6. Note that any operations or signaling illustrated with dashed lines may indicate that that operation or signaling is an optional or alternative example.

At 908, the apparatus 902 obtains, from one or more UEs of the group of UEs 906, a respective vote for mobility to a cell (e.g., the respective votes 616 and/or the respective votes 618 as described with reference to FIG. 6). For example, for each of the one or more UEs of the group of UEs 906, the respective vote may indicate to perform mobility to the cell (e.g., ‘yes’ vote) or not perform mobility to the cell (e.g., ‘no’ vote).

At 910, the apparatus 902 may obtain, from the one or more UEs of the group of UEs 906, a respective confidence value for the respective vote of each of the one or more UEs of the group of UEs 906 (e.g., as described with reference to FIG. 6).

At 912, the apparatus 902 sends, to the group of UEs 906, a voting result (e.g., the voting result 620 as described with reference to FIG. 6) for mobility to the cell based on the respective vote of each of the one or more UEs of the group of UEs 906. For example, the voting result may be one of: a majority among the respective vote of each of the one or more UEs of the group of UEs 906; or a first value when any of the respective vote of each of the one or more UEs of the group of UEs 906 has the first value (e.g., a single ‘yes’ vote or a single ‘no’ vote). In some aspects, the voting result may further be based on the respective confidence value for the respective vote of each of the one or more UEs of the group of UEs 906. In some aspects, when the apparatus 902 represents a network entity, the voting result may include a handoff command.

Note that the process flow illustrated in FIG. 9 is an example of coordinating a mobility decision for a group of devices based on a voting result, and aspects of the present disclosure may be applied to coordinating a mobility decision for a group of devices based on a voting result. Note that the process flow illustrated in FIG. 9 is described herein to facilitate an understanding of coordinating a mobility decision for a group of devices based on a voting result, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations

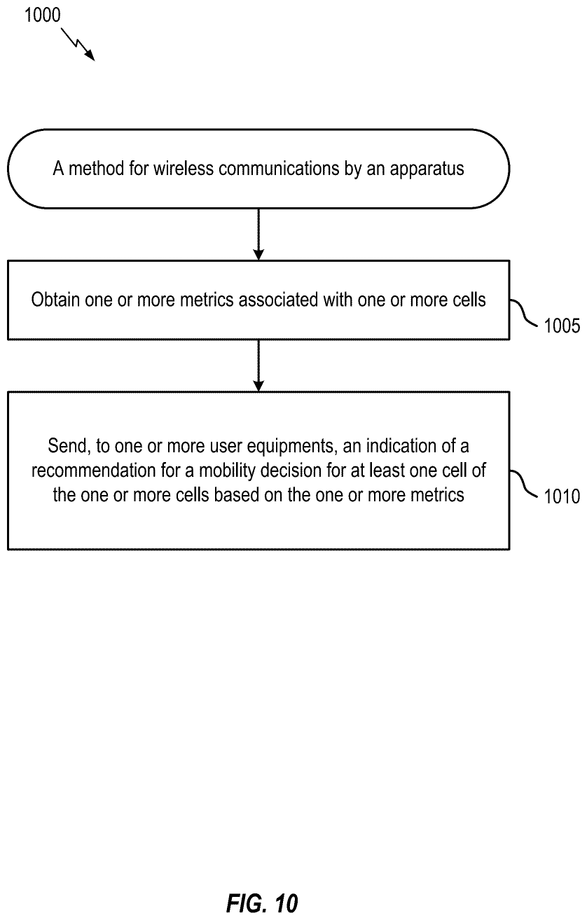

FIG. 10 shows a method 1000 for wireless communications by an apparatus, such as UE 104 of FIGS. 1 and 3.

Method 1000 begins at block 1005 with obtaining one or more metrics associated with one or more cells (e.g., the one or more measurements 514 and/or the one or more cell metrics 516 as described with reference to FIG. 5).

Method 1000 then proceeds to block 1010 with sending, to one or more UEs, an indication of a recommendation for a mobility decision for at least one cell of the one or more cells (e.g., the recommendation 518 as described with reference to FIG. 5) based on the one or more metrics.

In one aspect, the recommendation comprises a recommendation to search for the at least one cell.

In one aspect, the recommendation comprises a recommendation to switch to the at least one cell.

In one aspect, the recommendation comprises a recommendation to avoid the at least one cell for mobility to the one or more cells.

In one aspect, method 1000 further includes receiving, from at least one user equipment of the one or more UEs, a request for the recommendation.

In one aspect, method 1000 further includes receiving, from at least one user equipment of the one or more UEs, a respective recommendation for the at least one cell; and the recommendation for the mobility decision for the at least one cell is based on the respective recommendation from the at least one user equipment of the one or more UEs.

In one aspect, block 1010 includes unicasting or broadcasting the indication to each of the one or more UEs.

In one aspect, block 1005 includes one or more of: measuring one or more reference signals associated with at least one of the one or more cells; or receiving at least one of the one or more metrics from the one or more UEs.

In one aspect, method 1000 further includes inputting the one or more metrics into a machine learning model.

In one aspect, method 1000 further includes receiving, as output from the machine learning model, the recommendation.

In one aspect, the indication of the recommendation comprises an indication that the user equipment has determined to perform mobility to the at least one cell.

In one aspect, block 1010 includes sending the indication of the recommendation in response to a metric associated with the at least one cell satisfying a threshold.

In one aspect, the indication of the recommendation comprises a target cell identifier associated with the at least one cell.

In one aspect, the indication of the recommendation comprises a signal strength associated with the at least one cell.

In one aspect, method 1000 further includes receiving, from a network entity, a configuration of one or more conditions on which to base the recommendation.

In one aspect, the one or more conditions comprise one or more of: a first signal strength of the at least one cell at the user equipment satisfying a first threshold; a second signal strength of the at least one cell at a second user equipment of the one or more UEs satisfying a second threshold; reception of a recommendation of the at least one cell from the second user equipment; or reception of a threshold number of recommendations of the at least one cell from the one or more UEs.

In one aspect, method 1000 further includes receiving, from the network entity, a second configuration of one or more second conditions on which to base the recommendation; the configuration is for individual user equipment mobility assessment; and the second configuration is for group user equipment mobility assessment.

In one aspect, method 1000 further includes receiving, from a network entity, an indication to active or deactivate one or more of individual user equipment mobility assessment or group user equipment mobility assessment.

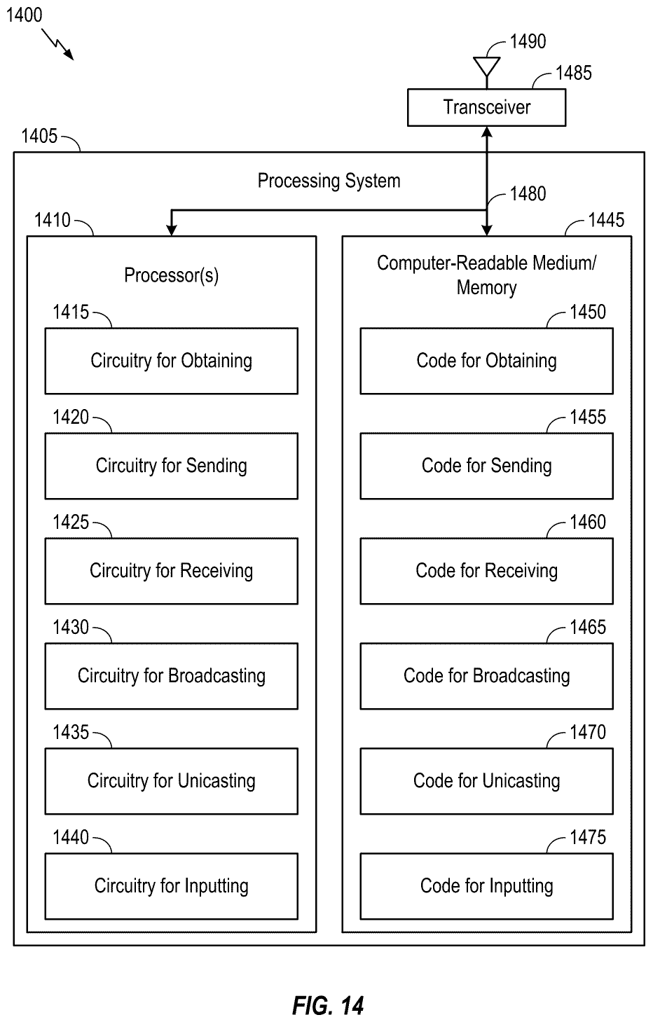

In one aspect, method 1000, or any aspect related to it, may be performed by an apparatus, such as communications device 1400 of FIG. 14, which includes various components operable, configured, or adapted to perform the method 1000. Communications device 1400 is described below in further detail.

Note that FIG. 10 is just one example of a method, and other methods including fewer, additional, or alternative operations are possible consistent with this disclosure.

In certain aspects, method 1000 may be performed by the apparatus to realize one or more technical effects or solutions to the aforementioned technical problem(s). For example, based on method 1000, a UE-initiated group mobility may provide an optimal mobility decision for a group of UEs via the recommendation rather than each individual UE of the group of UEs making a mobility decision on its own.

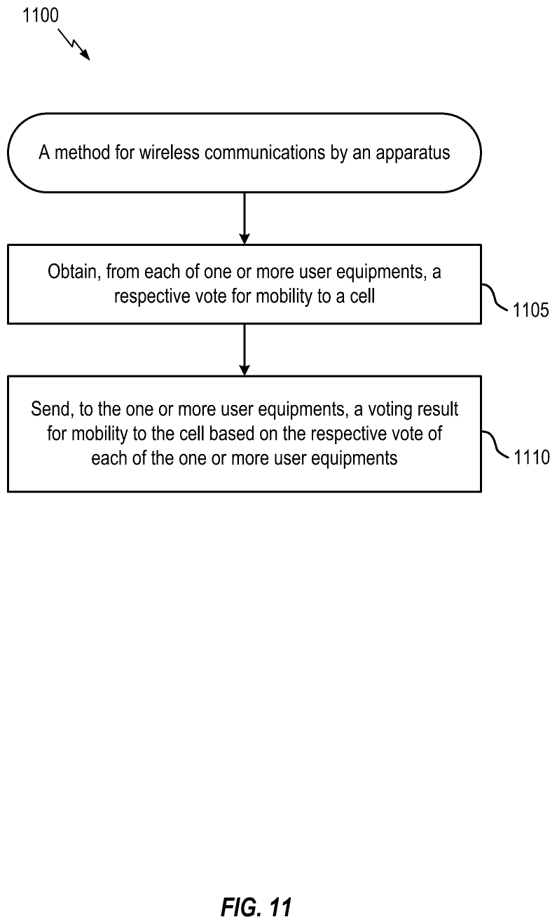

FIG. 11 shows a method 1100 of wireless communications by an apparatus, such as UE 104 of FIGS. 1 and 3, BS 102 of FIGS. 1 and 3, or a disaggregated base station discussed with respect to FIG. 2.

Method 1100 begins at block 1105 with obtaining, from each of one or more UEs, a respective vote for mobility to a cell (e.g., the respective votes 616 and/or the respective votes 618 as described with reference to FIG. 6).

Method 1100 then proceeds to block 1110 with sending, to the one or more UEs, a voting result for mobility to the cell (e.g., the voting result 620 as described with reference to FIG. 6) based on the respective vote of each of the one or more UEs.

In one aspect, for each of the one or more UEs, the respective vote indicates to perform mobility to the cell or not perform mobility to the cell.

In one aspect, method 1100 further includes obtaining, from each of one or more UEs, a respective confidence value for the respective vote of each of the one or more UEs; and the voting result is further based on the respective confidence value for the respective vote of each of the one or more UEs.

In one aspect, the voting result is one of: a majority among the respective vote of each of the one or more UEs; or a first value when any of the respective vote of each of the one or more UEs has the first value.

In one aspect, the apparatus comprises a user equipment.

In one aspect, the apparatus comprises a network entity.

In one aspect, the voting result comprises a handoff command.

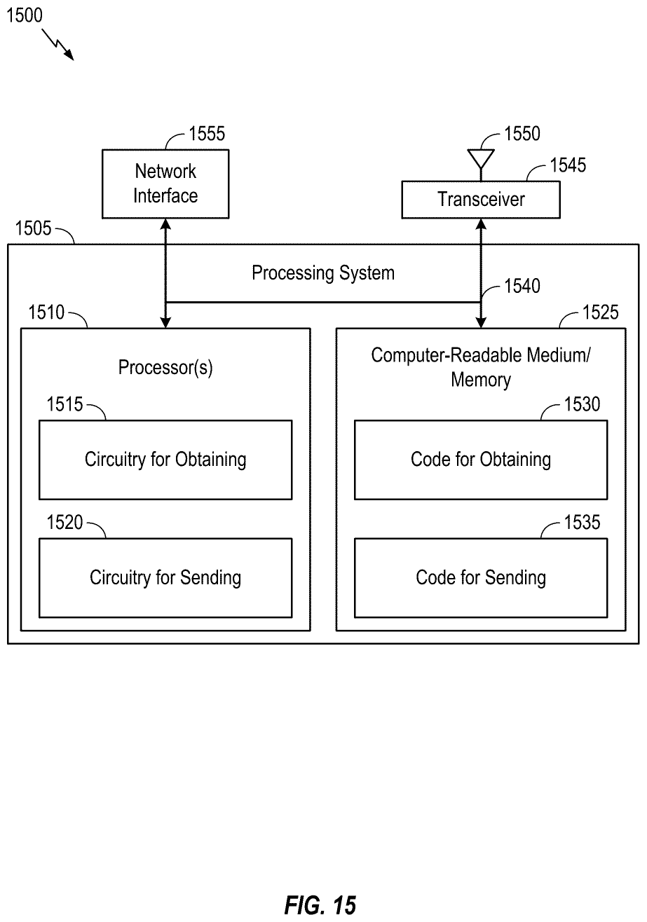

In one aspect, method 1100, or any aspect related to it, may be performed by an apparatus, such as communications device 1500 of FIG. 15, which includes various components operable, configured, or adapted to perform the method 1100. Communications device 1500 is described below in further detail.

Note that FIG. 11 is just one example of a method, and other methods including fewer, additional, or alternative operations are possible consistent with this disclosure.

In certain aspects, method 1100 may be performed by the apparatus to realize one or more technical effects or solutions to the aforementioned technical problem(s). For example, based on method 1100, a UE-initiated group mobility may provide an optimal mobility decision for a group of UEs via the recommendation rather than each individual UE of the group of UEs making a mobility decision on its own. Additionally, based on method 1100, an apparatus may reduce its own power consumption by not performing the measurements and may obtain respective votes for the recommendation from the other UEs in the group of UEs. Additionally or alternatively, if the network entity provides the recommendation as described previously, then signaling overhead may decrease based on the network entity sending a single handover command to the group of UEs rather than sending individual handoff commands to each UE.

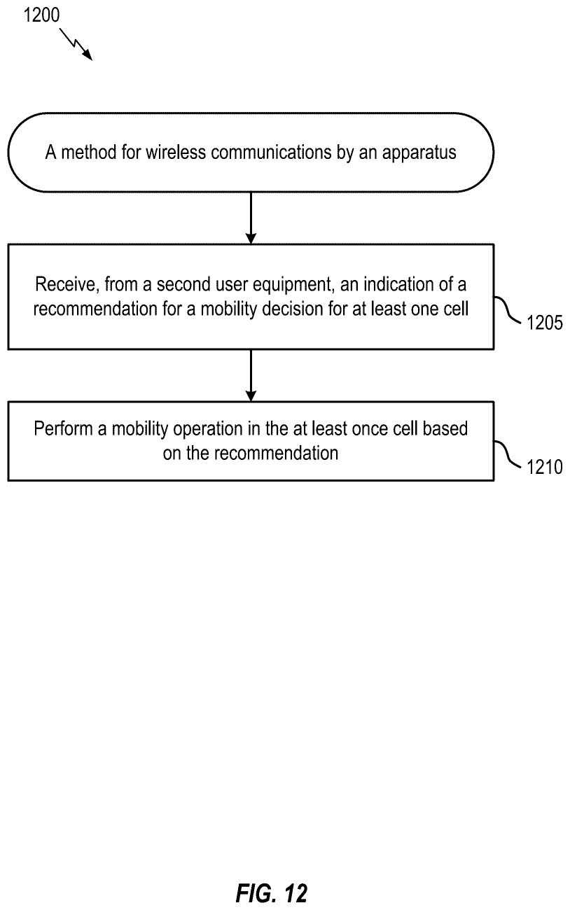

FIG. 12 shows a method 1200 for wireless communications by an apparatus, such as UE 104 of FIGS. 1 and 3.

Method 1200 begins at block 1205 with receiving, from a second user equipment, an indication of a recommendation for a mobility decision for at least one cell (e.g., the recommendation 518 as described with reference to FIG. 5).

Method 1200 then proceeds to block 1210 with performing a mobility operation in the at least one cell based on the recommendation.

In one aspect, the recommendation comprises a recommendation to search for the at least one cell.

In one aspect, the recommendation comprises a recommendation to switch to the at least one cell.

In one aspect, the recommendation comprises a recommendation to avoid the at least one cell for mobility to the one or more cells.

In one aspect, method 1200 further includes sending, to the second user equipment, a request for the recommendation.

In one aspect, method 1200 further includes sending, to the second user equipment, a respective recommendation for the at least one cell.

In one aspect, block 1205 includes receiving the indication in a unicast transmission or a broadcast transmission.

In one aspect, the indication of the recommendation comprises an indication that the second user equipment has determined to perform mobility to the at least one cell.

In one aspect, the indication of the recommendation comprises a target cell identifier associated with the at least one cell.

In one aspect, the indication of the recommendation comprises a signal strength associated with the at least one cell.

In one aspect, method 1200, or any aspect related to it, may be performed by an apparatus, such as communications device 1400 of FIG. 14 and communications device 1500 of FIG. 15, which includes various components operable, configured, or adapted to perform the method 1200. Communications device 1400 and communications device 1500 are described below in further detail.

Note that FIG. 12 is just one example of a method, and other methods including fewer, additional, or alternative operations are possible consistent with this disclosure.

In certain aspects, method 1200 may be performed by the apparatus to realize one or more technical effects or solutions to the aforementioned technical problem(s). For example, based on method 1200, a UE-initiated group mobility may provide an optimal mobility decision for a group of UEs via the recommendation rather than each individual UE of the group of UEs making a mobility decision on its own. Additionally, based on method 1100, an apparatus may reduce power consumption by not performing cell measurements and determining a mobility decision based on receiving a recommendation.

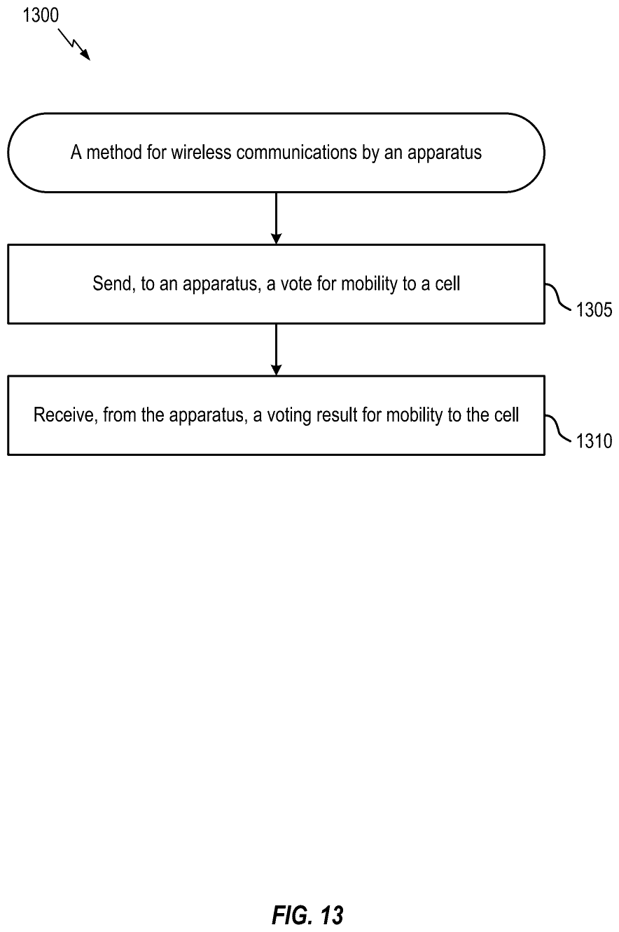

FIG. 13 shows a method 1300 for wireless communications by an apparatus, such as UE 104 of FIGS. 1 and 3.

Method 1300 begins at block 1305 with sending, to an apparatus, a vote for mobility to a cell (e.g., the respective votes 616 and/or the respective votes 618 as described with reference to FIG. 6).

Method 1300 then proceeds to block 1310 with receiving, from the apparatus, a voting result for mobility to the cell (e.g., the voting result 620 as described with reference to FIG. 6).

In one aspect, the respective vote indicates to perform mobility to the cell or not perform mobility to the cell.

In one aspect, method 1300 further includes sending, to the apparatus, a confidence value for the vote.

In one aspect, the apparatus comprises a second user equipment.

In one aspect, the apparatus comprises a network entity.

In one aspect, the voting result comprises a handoff command.

In one aspect, method 1300, or any aspect related to it, may be performed by an apparatus, such as communications device 1400 of FIG. 14 and communications device 1500 of FIG. 15, which includes various components operable, configured, or adapted to perform the method 1300. Communications device 1400 and communications device 1500 are described below in further detail.

Note that FIG. 13 is just one example of a method, and other methods including fewer, additional, or alternative operations are possible consistent with this disclosure.

In certain aspects, method 1300 may be performed by the apparatus to realize one or more technical effects or solutions to the aforementioned technical problem(s). For example, based on method 1300, a UE-initiated group mobility may provide an optimal mobility decision for a group of UEs via the recommendation rather than each individual UE of the group of UEs making a mobility decision on its own.

### Example Communications Devices

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to a transceiver 1485 (e.g., a transmitter and/or a receiver). The transceiver 1485 is configured to transmit and receive signals for the communications device 1400 via an antenna 1490, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1445 via a bus 1480. In certain aspects, the computer-readable medium/memory 1445 is configured to store instructions (e.g., computer-executable code), including code 1450-1475, that when executed by the one or more processors 1410, enable and cause the one or more processors 1410 to perform the method 1000 described with respect to FIG. 10, or any aspect related to it, including any operations described in relation to FIG. 10. Note that reference to a processor performing a function of communications device 1400 may include one or more processors performing that function of communications device 1400, such as in a distributed fashion.

In the depicted example, computer-readable medium/memory 1445 stores code for obtaining 1450, code for sending 1455, code for receiving 1460, code for broadcasting 1465, code for unicasting 1470, and code for inputting 1475. Processing of the code 1450-1475 may enable and cause the communications device 1400 to perform the method 1000 described with respect to FIG. 10, or any aspect related to it.

The one or more processors 1410 include circuitry configured to implement (e.g., execute) the code (e.g., executable instructions) stored in the computer-readable medium/memory 1445, including circuitry for obtaining 1415, circuitry for sending 1420, circuitry for receiving 1425, circuitry for broadcasting 1430, circuitry for unicasting 1435, and circuitry for inputting 1440. Processing with circuitry 1415-1440 may enable and cause the communications device 1400 to perform the method 1000 described with respect to FIG. 10, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1485 and/or antenna 1490 of the communications device 1400 in FIG. 14, and/or one or more processors 1410 of the communications device 1400 in FIG. 14. Means for communicating, receiving or obtaining may include the transceivers 354, antenna(s) 352, receive processor 358, AI processor 370, and/or controller/processor 380 of the UE 104 illustrated in FIG. 3, transceiver 1485 and/or antenna 1490 of the communications device 1400 in FIG. 14, and/or one or more processors 1410 of the communications device 1400 in FIG. 14.

FIG. 15 depicts aspects of an example communications device 1500. In some aspects, communications device 1500 is a user equipment, such as UE 104 described above with respect to FIGS. 1 and 3. In some aspects, communications device 1500 is a network entity, such as BS 102 of FIGS. 1 and 3, or a disaggregated base station as discussed with respect to FIG. 2.

The communications device 1500 includes a processing system 1505 coupled to a transceiver 1545 (e.g., a transmitter and/or a receiver) and/or a network interface 1555. The transceiver 1545 is configured to transmit and receive signals for the communications device 1500 via an antenna 1550, such as the various signals as described herein. The network interface 1555 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 338, receive processor 358, transmit processor 320, transmit processor 364, TX MIMO processor 330, TX MIMO processor 366, controller/processor 340, and/or controller/processor 380, as described with respect to FIG. 3. The one or more processors 1510 are coupled to a computer-readable medium/memory 1525 via a bus 1540. In certain aspects, the computer-readable medium/memory 1525 is configured to store instructions (e.g., computer-executable code), including code 1530 and 1535, that when executed by the one or more processors 1510, enable and cause the one or more processors 1510 to perform the method 1100 described with respect to FIG. 11, or any aspect related to it, including any operations described in relation to FIG. 11. Note that reference to a processor performing a function of communications device 1500 may include one or more processors performing that function of communications device 1500, such as in a distributed fashion.

In the depicted example, computer-readable medium/memory 1525 stores code for obtaining 1530 and code for sending 1535. Processing of the code 1530 and 1535 may enable and cause the communications device 1500 to perform the method 1100 described with respect to FIG. 11, or any aspect related to it.

The one or more processors 1510 include circuitry configured to implement (e.g., execute) the code (e.g., executable instructions) stored in the computer-readable medium/memory 1525, including circuitry for obtaining 1515 and circuitry for sending 1520. Processing with circuitry 1515 and 1520 may enable and cause the communications device 1500 to perform the method 1100 described with respect to FIG. 11, or any aspect related to it.

Various components of the communications device 1500 may provide means for performing the method 1100 described with respect to FIG. 11, or any aspect related to it. Means for communicating, transmitting, sending or outputting for transmission may include: the transceivers 332, antenna(s) 334, transmit processor 320, TX MIMO processor 330, AI processor 318, and/or controller/processor 340 of the BS 102 illustrated in FIG. 3; the transceivers 354, antenna(s) 352, transmit processor 364, TX MIMO processor 366, AI processor 370, and/or controller/processor 380 of the UE 104 illustrated in FIG. 3; transceiver 1545, antenna 1550, and/or network interface 1555 of the communications device 1500 in FIG. 15; and/or one or more processors 1510 of the communications device 1500 in FIG. 15. Means for communicating, receiving or obtaining may include: the transceivers 332, antenna(s) 334, receive processor 338, AI processor 318, and/or controller/processor 340 of the BS 102 illustrated in FIG. 3; the transceivers 354, antenna(s) 352, receive processor 358, AI processor 370, and/or controller/processor 380 of the UE 104 illustrated in FIG. 3; transceiver 1545, antenna 1550, and/or network interface 1555 of the communications device 1500 in FIG. 15; and/or one or more processors 1504 of the communications device 1500 in FIG. 15.

### Example Clauses

Implementation examples are described in the following numbered clauses:
Clause 1: A method for wireless communications by an apparatus comprising: obtaining one or more metrics associated with one or more cells; and sending, to one or more user equipments, an indication of a recommendation for a mobility decision for at least one cell of the one or more cells based on the one or more metrics.
Clause 2: The method of Clause 1, wherein the recommendation comprises a recommendation to search for the at least one cell.
Clause 3: The method of any one of Clauses 1-2, wherein the recommendation comprises a recommendation to switch to the at least one cell.
Clause 4: The method of any one of Clauses 1-3, wherein the recommendation comprises a recommendation to avoid the at least one cell for mobility to the one or more cells.
Clause 5: The method of any one of Clauses 1-4, further comprising: receiving, from at least one user equipment of the one or more user equipments, a request for the recommendation.
Clause 6: The method of any one of Clauses 1-5, further comprising: receiving, from at least one user equipment of the one or more user equipments, a respective recommendation for the at least one cell; and the recommendation for the mobility decision for the at least one cell is based on the respective recommendation from the at least one user equipment of the one or more user equipments.
Clause 7: The method of any one of Clauses 1-6, wherein sending the indication comprises unicasting or broadcasting the indication to each of the one or more user equipments.
Clause 8: The method of any one of Clauses 1-7, wherein obtaining the one or more metrics comprises one or more of: measuring one or more reference signals associated with at least one of the one or more cells; or receiving at least one of the one or more metrics from the one or more user equipments.
Clause 9: The method of any one of Clauses 1-8, further comprising: inputting the one or more metrics into a machine learning model; and receiving, as output from the machine learning model, the recommendation.
Clause 10: The method of any one of Clauses 1-9, wherein the indication of the recommendation comprises an indication that the user equipment has determined to perform mobility to the at least one cell.
Clause 11: The method of any one of Clauses 1-10, wherein sending the indication of the recommendation comprises sending the indication of the recommendation in response to a metric associated with the at least one cell satisfying a threshold.
Clause 12: The method of any one of Clauses 1-11, wherein the indication of the recommendation comprises a target cell identifier associated with the at least one cell.
Clause 13: The method of any one of Clauses 1-12, wherein the indication of the recommendation comprises a signal strength associated with the at least one cell.
Clause 14: The method of any one of Clauses 1-13, further comprising receiving, from a network entity, a configuration of one or more conditions on which to base the recommendation.
Clause 15: The method of Clause 14, wherein the one or more conditions comprise one or more of: a first signal strength of the at least one cell at the user equipment satisfying a first threshold; a second signal strength of the at least one cell at a second user equipment of the one or more user equipments satisfying a second threshold; reception of a recommendation of the at least one cell from the second user equipment; or reception of a threshold number of recommendations of the at least one cell from the one or more user equipments.
Clause 16: The method of Clause 14, further comprising: receiving, from the network entity, a second configuration of one or more second conditions on which to base the recommendation; the configuration is for individual user equipment mobility assessment; and the second configuration is for group user equipment mobility assessment.
Clause 17: The method of Clause 16, further comprising receiving, from a network entity, an indication to active or deactivate one or more of individual user equipment mobility assessment or group user equipment mobility assessment.
Clause 18: A method for wireless communications by an apparatus comprising: obtaining, from each of one or more user equipments, a respective vote for mobility to a cell; and sending, to the one or more user equipments, a voting result for mobility to the cell based on the respective vote of each of the one or more user equipments.
Clause 19: The method of Clause 18, wherein for each of the one or more user equipments, the respective vote indicates to perform mobility to the cell or not perform mobility to the cell.
Clause 20: The method of any one of Clauses 18-19, further comprising: obtaining, from each of one or more user equipments, a respective confidence value for the respective vote of each of the one or more user equipments; and the voting result is further based on the respective confidence value for the respective vote of each of the one or more user equipments.
Clause 21: The method of any one of Clauses 18-20, wherein the voting result is one of: a majority among the respective vote of each of the one or more user equipments; or a first value when any of the respective vote of each of the one or more user equipments has the first value.
Clause 22: The method of any one of Clauses 18-21, wherein the apparatus comprises a user equipment.
Clause 23: The method of any one of Clauses 18-22, wherein the apparatus comprises a network entity.
Clause 24: The method of Clause 23, wherein the voting result comprises a handoff command.
Clause 25: A method for wireless communications by an apparatus comprising: receiving, from a second user equipment, an indication of a recommendation for a mobility decision for at least one cell; and performing a mobility operation in the at least one cell based on the recommendation.
Clause 26: The method of Clause 25, wherein the recommendation comprises a recommendation to search for the at least one cell.
Clause 27: The method of any one of Clauses 25-26, wherein the recommendation comprises a recommendation to switch to the at least one cell.
Clause 28: The method of any one of Clauses 25-27, wherein the recommendation comprises a recommendation to avoid the at least one cell for mobility to the one or more cells.
Clause 29: The method of any one of Clauses 25-28, further comprising sending, to the second user equipment, a request for the recommendation.
Clause 30: The method of any one of Clauses 25-29, further comprising sending, to the second user equipment, a respective recommendation for the at least one cell.
Clause 31: The method of any one of Clauses 25-30, wherein receiving the indication comprises receiving the indication in a unicast transmission or a broadcast transmission.
Clause 32: The method of any one of Clauses 25-31, wherein the indication of the recommendation comprises an indication that the second user equipment has determined to perform mobility to the at least one cell.
Clause 33: The method of any one of Clauses 25-32, wherein the indication of the recommendation comprises a target cell identifier associated with the at least one cell.
Clause 34: The method of any one of Clauses 25-33, wherein the indication of the recommendation comprises a signal strength associated with the at least one cell.
Clause 35: A method for wireless communications by an apparatus comprising: sending, to an apparatus, a vote for mobility to a cell; and receiving, from the apparatus, a voting result for mobility to the cell.
Clause 36: The method of Clause 35, wherein the respective vote indicates to perform mobility to the cell or not perform mobility to the cell.
Clause 37: The method of any one of Clauses 35-36, further comprising sending, to the apparatus, a confidence value for the vote.
Clause 38: The method of any one of Clauses 35-37, wherein the apparatus comprises a second user equipment.
Clause 39: The method of any one of Clauses 35-38, wherein the apparatus comprises a network entity.
Clause 40: The method of Clause 39, wherein the voting result comprises a handoff command.
Clause 41: One or more apparatuses, comprising: one or more memories comprising executable instructions; and one or more processors configured to execute the executable instructions and cause the one or more apparatuses to perform a method in accordance with any one of Clauses 1-40.
Clause 42: One or more apparatuses, comprising: one or more memories; and one or more processors, coupled to the one or more memories, configured to cause the one or more apparatuses to perform a method in accordance with any one of Clauses 1-40.
Clause 43: One or more apparatuses, comprising: one or more memories; and one or more processors, coupled to the one or more memories, configured to perform a method in accordance with any one of Clauses 1-40.
Clause 44: One or more apparatuses, comprising means for performing a method in accordance with any one of Clauses 1-40.
Clause 45: One or more non-transitory computer-readable media comprising executable instructions that, when executed by one or more processors of one or more apparatuses, cause the one or more apparatuses to perform a method in accordance with any one of Clauses 1-40.
Clause 46: One or more computer program products embodied on one or more computer-readable storage media comprising code for performing a method in accordance with any one of Clauses 1-40.
Clause 47: One or more apparatuses configured for wireless communications, comprising: a processing system that includes one or more processors and one or more memories coupled with the one or more processors, the processing system configured to cause the one or more apparatuses to perform a method in accordance with any one of Clauses 1-40.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more. ” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more. ” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A user equipment configured for wireless communications, comprising:
a processing system that includes one or more processors and one or more memories coupled with the one or more processors, the processing system configured to cause the user equipment to:
obtain one or more metrics associated with one or more cells; and
send, to one or more user equipments, an indication of a recommendation for a mobility decision for at least one cell of the one or more cells based on the one or more metrics.

2. The user equipment of claim 1, wherein the recommendation comprises a recommendation to search for the at least one cell, a recommendation to switch to the at least one cell, a recommendation to avoid the at least one cell for mobility to the one or more cells, or a combination thereof.

3. The user equipment of claim 1, wherein the processing system is configured to cause the user equipment to receive, from at least one user equipment of the one or more user equipments, a request for the recommendation.

4. The user equipment of claim 1, wherein:
the processing system is configured to cause the user equipment to receive, from at least one user equipment of the one or more user equipments, a respective recommendation for the at least one cell; and
the recommendation for the mobility decision for the at least one cell is based on the respective recommendation from the at least one user equipment of the one or more user equipments.

5. The user equipment of claim 1, wherein to cause the user equipment to send the indication, the processing system is configured to cause the user equipment to unicast or broadcast the indication to each of the one or more user equipments.

6. The user equipment of claim 1, wherein to cause the user equipment to obtain the one or more metrics, the processing system is configured to cause the user equipment to one or more of:
measure one or more reference signals associated with at least one of the one or more cells; or
receive at least one of the one or more metrics from the one or more user equipments.

7. The user equipment of claim 1, wherein the processing system is configured to cause the user equipment to:
input the one or more metrics into a machine learning model; and
receive, as output from the machine learning model, the recommendation.

8. The user equipment of claim 1, wherein to cause the user equipment to send the indication of the recommendation, the processing system is configured to cause the user equipment to send the indication of the recommendation in response to a metric associated with the at least one cell satisfying a threshold.

9. The user equipment of claim 1, wherein the indication of the recommendation comprises an indication that the user equipment has determined to perform mobility to the at least one cell, a target cell identifier associated with the at least one cell, a signal strength associated with the at least one cell, or a combination thereof.

10. The user equipment of claim 1, wherein the processing system is configured to cause the user equipment to receive, from a network entity, a configuration of one or more conditions on which to base the recommendation.

11. The user equipment of claim 10, wherein the one or more conditions comprise one or more of:
a first signal strength of the at least one cell at the user equipment satisfying a first threshold;
a second signal strength of the at least one cell at a second user equipment of the one or more user equipments satisfying a second threshold;
reception of a recommendation of the at least one cell from the second user equipment; or
reception of a threshold number of recommendations of the at least one cell from the one or more user equipments.

12. The user equipment of claim 10, wherein:
the processing system is configured to cause the user equipment to receive, from the network entity, a second configuration of one or more second conditions on which to base the recommendation;
the configuration is for individual user equipment mobility assessment; and
the second configuration is for group user equipment mobility assessment.

13. The user equipment of claim 12, wherein the processing system is configured to cause the user equipment to receive, from the network entity, an indication to active or deactivate one or more of individual user equipment mobility assessment or group user equipment mobility assessment.

14. An apparatus configured for wireless communications, comprising:
a processing system that includes one or more processors and one or more memories coupled with the one or more processors, the processing system configured to cause the apparatus to:
obtain, from each of one or more user equipments, a respective vote for mobility to a cell; and
send, to the one or more user equipments, a voting result for mobility to the cell based on the respective vote of each of the one or more user equipments.

15. The apparatus of claim 14, wherein, for each of the one or more user equipments, the respective vote indicates to perform mobility to the cell or not perform mobility to the cell.

16. The apparatus of claim 14, wherein:
the processing system is configured to cause the apparatus to obtain, from each of one or more user equipments, a respective confidence value for the respective vote of each of the one or more user equipments; and
the voting result is further based on the respective confidence value for the respective vote of each of the one or more user equipments.

17. The apparatus of claim 14, wherein the voting result is one of:
a majority among the respective vote of each of the one or more user equipments; or
a first value when any of the respective vote of each of the one or more user equipments has the first value.

18. The apparatus of claim 17, wherein the apparatus comprises a user equipment or a network entity.

19. The apparatus of claim 14, wherein the voting result comprises a handoff command.

20. A user equipment configured for wireless communications, comprising:
a processing system that includes one or more processors and one or more memories coupled with the one or more processors, the processing system configured to cause the user equipment to:
receive, from a second user equipment, an indication of a recommendation for a mobility decision for at least one cell; and
perform a mobility operation in the at least one cell based on the recommendation.
